(19) United States
(12) Patent Application Publication
(10) Pub. No.: US 2024/0375477 A1
(43) Pub. Date: Nov. 14, 2024

(54) COMPONENT ARRANGEMENT FOR A FLUID-CONDUCTING TEMPERATURE CONTROL SYSTEM OF A VEHICLE, METHOD FOR MANUFACTURING A HOUSING BODY FOR THE COMPONENT ARRANGEMENT

(71) Applicant: HANON SYSTEMS EFP DEUTSCHLAND GMBH, Bad Homburg v.d. Höhe (DE)

(72) Inventors: Tilo Schäfer, Daubach (DE); Michael Krug, Gau-Bischofsheim (DE)

(21) Appl. No.: 18/554,152

(22) PCT Filed: May 5, 2022
(86) PCT No.: PCT/DE2022/100347

§ 371 Date: Oct. 5, 2023

(30) Foreign Application Priority Data
Jun. 23, 2021 (DE) 10 2021 116 233.5
Feb. 10, 2022 (DE) 10 2022 103 150.0

(51) Int. Cl. B60H 1/00

(52) U.S. Cl. CPC B60H 1/00521

(57) ABSTRACT

A component arrangement for a fluid-conducting temperature control system of a vehicle, preferably a battery-electric vehicle, the component arrangement having a housing body made by means of a plastic injection molding process and with at least one formation for receiving and for retaining at least one electrically operated component of the fluid-conducting temperature control system, and further having electrical contact elements connected to each other by means of electrical conductors, the electrical contact elements arranged in the formation for electrically contacting an electrically operable component received in the at least one formation and in at least one further connection position on the housing body, wherein the electrical conductors are integrated with the housing body by being over-molded with the material thereof.

### CROSS-REFERENCE TO RELATED PATENT APPLICATIONS

This patent application is a United States national phase patent application based on PCT/DE2022/100347 filed on May 5, 2022, which claims the benefit of German Patent Application No. 10 2022 103 150.0 filed on Feb. 10, 2022 and German Patent Application No. 10 2021 116 233.5 filed on Jun. 23, 2021, the entire disclosures of each of which are hereby incorporated herein by reference.

### TECHNICAL FIELD

The invention relates to a component arrangement for a fluid-conducting temperature control system of a vehicle, in particular an electric vehicle. Furthermore, the invention relates to a method for manufacturing a housing body for the component arrangement. The component arrangement is configured for use in a temperature control system, which is provided for temperature control of a vehicle interior and for temperature control of a vehicle battery.

### BACKGROUND

The technical implementation of temperature control systems for vehicles, in particular battery electric vehicles, requires a large number of components such as pumps, sensors, valves, fluid distribution manifolds, at least one fluid storage unit as an expansion tank and a fluid line network for handling different fluid flows. A compact arrangement of these components is desired for efficient use of the installation space available in vehicles. This comes with various challenges. On the one hand, a technical challenge of temperature control systems for battery electric vehicles is to ensure the most space-saving arrangement of fluid-carrying components such as fluid storage units, fluid lines and their connections to enable efficient handling of the fluid flows differently temperature-controlled for the different temperature zones in the vehicle interior and for the temperature control of the on-board battery. On the other hand, there is a challenge in the electrical connection of electrically operated components such as pumps, electrical valves and control units that are arranged in a space saving manner. Accommodating the electrical connections and the electrical conductors requires additional installation space between the compactly arranged components of the temperature control system. The compact arrangement of the fluid-carrying components and the electrically operated components also makes it more difficult to assemble the electrical elements for making electrical contact with the electrically operated components. Due to the structural freedom or assembly space required for this purpose, which enables accessibility to the electrically operated components, an even more compact arrangement of the components of a fluid-conducting temperature control system of a vehicle or electric vehicle is limited.

### SUMMARY

It is therefore an object of the invention to create a possibility by which an even more compact arrangement of components of a temperature control system of a vehicle, in particular a battery electrically operated vehicle, can be ensured. Furthermore, it is an object of the invention to propose a method for manufacturing a housing body for implementing a compact component arrangement for a temperature control system of a vehicle, in particular a battery electrically operated vehicle.

The object is achieved by a component arrangement with the features s shown and described herein.

A component arrangement for a fluid-conducting temperature control system of a vehicle, preferably a battery electric vehicle, is proposed. The component arrangement has a housing body made by means of a plastic injection molding process and with at least one formation for receiving and retaining at least one electrically operated component of the fluid-conducting temperature control system. The housing body can be formed, for example, as a fluid storage unit or expansion tank for a fluid of the temperature control system, with the fluid entering the housing body via at least one opening that forms a fluid interface with a fluid line network of the temperature control system. The housing body can therefore be integrated into the temperature control system of a vehicle or electric vehicle as a fluid-carrying component. According to the invention, the housing body has at least one formation for receiving and retaining at least one electrically operated component of the temperature control system. An electrically operated component of the temperature control system is, for example, an electrically operated pump, an electrically operated valve or a control unit (Electronic Control Unit, ECU) for controlling the electrically operated pump and/or for controlling the electrically operated valve. The housing body has at least one formation for receiving an electrically operated pump. According to an advantageous configuration of the component arrangement, the housing body can each have a formation for receiving and retaining an electrically operated pump, an electric control unit and an electrically operated valve. A plurality of components can thus advantageously be received and retained in a compact arrangement in accordance with the geometric arrangement of the formations.

Consequently, due to the fact that the housing body is formed to receive and retain electrically operated components of the temperature control system, a particularly compact arrangement of components of the temperature control system can be ensured. The formation preferably forms a plug-in receptacle for the electrically operated components.

According to the invention, the component arrangement has electrical contact elements connected to each other by means of electrical conductors, which are arranged in the formation for electrically contacting an electrically operable component received in the at least one formation and in at least one further connection position on the housing body. In this case, the electrical conductors are integrated with the housing body by being over-molded with the material thereof. Because the electrical conductors and the electrical contact elements are integrated with the housing body and formed for electrically contacting, the components of the temperature control system can be arranged in an even more compact manner, since installation space for the electrical elements such as electrical conductors and electrical contact elements can be saved. The fact that the electrical conductors can be formed as flat conductors also contributes to the compact arrangement. Flat conductors require less space, so that the material thickness of the housing body can be kept small. This can save weight.

The electrical contact elements are preferably formed in the at least one formation of the housing body in such a way that the electrical component is electrically contacted by being received in the formation, which can be formed as a plug-in housing for the electrically operated component. This advantageously simplifies assembly, since there is no need to assemble electrical conductors in the form of cables.

According to a refinement, the housing body is advantageously used as a fluid storage unit or fluid reservoir, with at least one opening in the housing body ensuring a fluid connection to a fluid line network of the temperature control system. Furthermore, the electrical conductors and electrical contact elements are advantageously integrated with the housing body, so that electrically operated components of the temperature control system received in the formations can be supplied with electrical energy. The invention thus advantageously combines several components of the temperature control system in a compact component arrangement.

The electrical contact elements can be arranged in a formation of the housing body that forms a plug-in housing for a plug-in element. Formations forming such plug-in housings can be formed during the production of the housing body by means of a plastic injection molding process. Advantageously, plug-in housing-plug connections provide protection against the ingress of dust and/or liquid.

The at least one connection position, at which the electrical contact elements are arranged, can be arranged on an outside, preferably on a side wall of the housing body.

According to an advantageous configuration of the component arrangement according to the invention, a plurality of the electrical contact elements can be grouped together in the at least one connection position, wherein electrical conductors connected to the electrical contact elements lead from the at least one connection position to a plurality of electrical elements arranged in the formations for receiving and retaining at least one electrically operated component. In this case, the connection position can be formed on an outside of the housing body in the form of a formation forming a plug-in housing. Starting from the connection position, the integrated electrical conductors run through the material of the housing body to the electrical contact elements, which are arranged in the formations for receiving and retaining the electrically operated components. The central arrangement of a plurality of electrical contact elements in a connection position has the advantage that only one plug-in connection is required for electrically contacting electrically operated components received in a plurality of formations of the housing body.

Furthermore, it can be provided that in configurations in which the housing body has a plurality of formations for accommodating and retaining electrically operated components, electrical contact elements arranged in the plurality of formations for receiving and retaining electrically operated components are connected to each other by means of the electrical conductors. In other words, the electrical components received in the formations can be electrically contacted with each other via the integrated electrical conductors. This is advantageous in particular when receiving an electrically operated control unit, which controls a plurality of received electrical components, the control commands for controlling the electrically operated components being transmitted by means of the electrical conductors. Thus, there is an electrical contact between the electrical contact elements arranged in the plurality of formations. However, it is not excluded that the electrical conductors are also formed between the electrical contact elements arranged in the formations and the contact elements of the connection position.

Advantageously, the plurality of formations for receiving and retaining at least one electrically operated component can be formed in such a way that an electrically operated component, in particular an electrically operated pump, is receivable in the formation for electrically contacting its back. In this case, the electrical contact elements are advantageously arranged in the formation in such a way that they correspond to the arrangement of the contact elements of the electrically operated component that is usually formed on the back. Plugging the electrically operated component into the formation thus inevitably leads to electrically contacting the electrically operated component.

The electrical conductors are advantageously formed from a bent lead frame. Such a lead frame can be used as an insert in the production of the housing body, with the electrical conductors being over-molded by the plastic of the housing body during the plastic injection molding process.

The housing body can be formed in multiple parts. According to a refinement of the component arrangement according to the invention, it can be provided that the housing body is formed of at least two housing body parts made by means of a plastic injection molding process. In this case, a first housing body part can be formed as a fluid container with an opening for a fluid of the fluid-conducting temperature control system. The opening is used as a fluid interface with fluid lines of the fluid-conducting temperature control system. The first housing body part forming the fluid container can also have further openings as fluid interfaces. A second housing body part can be formed specifically as a pump housing for receiving one pump or a plurality of pumps. The pump housing therefore has at least one formation formed to receive a pump. In this case, the electrical conductors can be formed in both housing body parts, with the housing body parts having electrical contact elements at their contact points at which they are connected to each other, which contact elements electrically contact the electrical conductors with each other.

The multi-part configuration of the housing body has the advantage that other functions can be assigned to the housing body parts in addition to the actual housing function. In this case, it has proven to be advantageous that the plastic material composition of the housing body parts can be adapted or varied with regard to their assigned function and the associated requirements. For example, the first housing body part, which forms the fluid container, is subject to different material expansion requirements than the pump housing due to temperature differences caused by the fluid. It can therefore be provided that the first housing body part and the second housing body part are formed from different plastic materials or different plastic material compositions. Thus, the first housing body part, which forms the fluid container, can be formed from a different plastic material than the second housing body part, which forms the pump housing.

The individual housing body parts can preferably be plugged together. It can be provided that each housing body part has a formation formed on the outside as an element of a plug-in connection, preferably a dovetail plug-in connection, so that the housing body parts are able to be plugged together. Furthermore, it can be provided that the housing body parts are joined to form the housing body.

The invention further relates to a method for manufacturing a housing body for the component arrangement according to the invention described above for a temperature control system of a vehicle or electric vehicle. In the method, a plurality of electrical conductor tracks, which form the electrical conductors in the cured housing body, are separated out of an electrically conductive flat material contiguously at connecting bridges and then at least partially over-molded with a plastic material such that, after cutting the connecting bridges, at least two electrical conductor tracks each are kept together by the plastic over-mold as retaining bridges. The electrical conductor tracks kept together in this manner at the retaining bridges are then placed in an injection mold and then over-molded by a plastic material to form the housing body for the component arrangement.

The connecting bridges are point-to-point connections made from the electrically conductive flat material between spaced-apart electrical conductor tracks. The connecting bridges are provided in order to obtain a contiguous network of electrical conductor tracks from the electrically conductive flat material. By separating the connecting bridges, the electrical conductor tracks are electrically separated. As a result of the plastic over-molds, which were previously formed at least partially and form the retaining bridges, the spaced-apart electrical conductor tracks are held together even after the connecting bridges have been separated, without being electrically conductively connected to each other. A contiguous insert is thus provided, which forms the electrical conductors in the cured housing body and the electrical contact elements at the ends of the electrical conductor tracks in each case.

The electrical conductor tracks can be punched out of the electrically conductive flat material, connected to each other at the connecting bridges, as a contiguous network. Such a contiguous network can also be referred to as a lead frame. The provision of the contiguous electrical conductor tracks by means of a punching tool represents a particularly favorable method for the production of large quantities.

Furthermore, it can be provided for the electrical conductor tracks connected to each other at connecting bridges to be separated out of the electrically conductive flat material as a coherent network by means of a laser cutting process. Separating out by means of a laser makes it possible to provide complex electrical conductor track structures with small distances between the individual electrical conductor tracks, as a result of which waste can be kept to a minimum. Laser cutting is also particularly suitable for the production of prototypes of electrical conductor track structures.

A sheet metal material, i. e. a metal sheet, can preferably be used as the electrically conductive flat material. The use of a flat material makes it possible to provide electrical conductors with a small thickness in relation to their width.

The electrical conductor tracks can be bent according to a pre-determined conductor track configuration before being placed in the injection mold. Thus, three-dimensional electrical conductor track configurations can be provided. The conductor track configurations correspond to the subsequent arrangement of the electrical conductors in the cured housing body.

The retaining bridges and the housing body are preferably made of the same plastic material. By using the same plastic material for the retaining bridges and the housing body, the retaining bridges can be fused with the plastic material during the injection molding of the housing body, with the electrical conductor tracks being integrated as electrical conductors in the plastic material of the housing body.

According to one embodiment of the method according to the invention, it can be provided that receiving structures and/or retaining structures in the form of formations are formed on the surface of the housing body in the injection molding process.

The housing body can be formed in multiple parts, housing body parts provided separately in the injection molding process being joined together. The housing body parts can be made of different plastics or plastic compositions.

The component arrangement according to the invention is provided in particular for use in a fluid-conducting temperature control system of an electric vehicle as a fluid storage unit for a fluid of the fluid-conducting temperature control system. The housing body advantageously is used as a carrier for electrically operated components of the fluid-conducting temperature control system. Furthermore, it can be provided that the housing body is also used as a carrier or retaining element for fluid-carrying lines of the temperature control system. Accordingly, receiving structures or retaining structures in the form of formations can be formed on the surface of the housing body.

### DESCRIPTION OF DRAWINGS

Further details, features and advantages of configurations of the invention result from the following description of exemplary embodiments with reference to the associated drawings. In the figures:

FIG. 1: shows a schematic sectional view of an exemplary embodiment of the component arrangement according to the invention for a fluid-conducting temperature control system of a battery electric vehicle,

FIGS. 2A-2C: show a sectional view of the housing body 2 shown in FIG. 1,

FIGS. 3A-3B: show a three-dimensional representation of the component arrangement shown in FIG. 1,

FIG. 4: shows a schematic representation in order to explain electrically contacting an electrically operated component of the component arrangement,

FIG. 5: shows a schematic representation of a configuration of electrical conductors within the component arrangement,

FIG. 6: shows a sectional representation of an exemplary embodiment of the housing body of the component arrangement,

FIG. 7: shows another sectional representation of the housing body 2 of the component arrangement according to the invention,

FIG. 8: shows a schematic representation of an exemplary embodiment of the component arrangement according to the invention,

FIGS. 9A-9C: show a schematic representation for a more detailed explanation of the method for manufacturing the housing body of the component arrangement according to the invention,

FIGS. 10A-10C: show a schematic representation of an exemplary embodiment of a refinement of the housing body of the component arrangement, and

FIGS. 11A-11B: show a detailed representation of housing body parts of the housing body shown in FIG. 10.

### DETAILED DESCRIPTION OF EMBODIMENTS

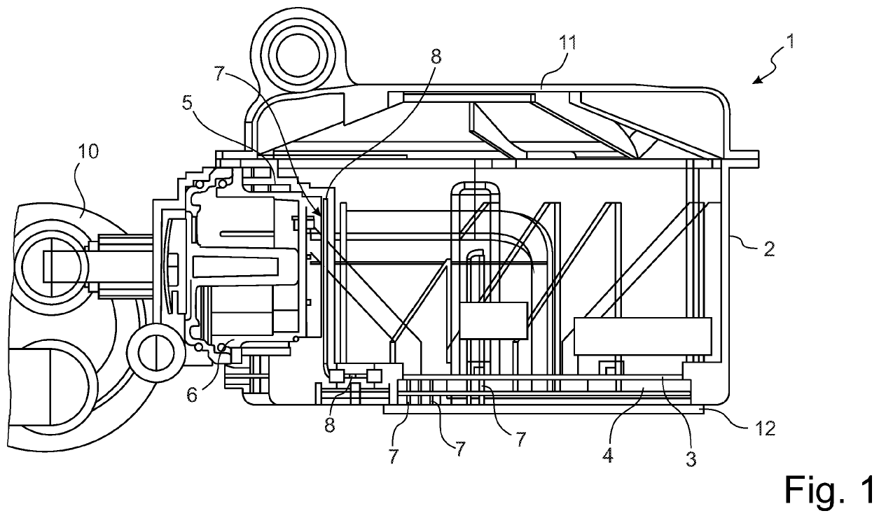

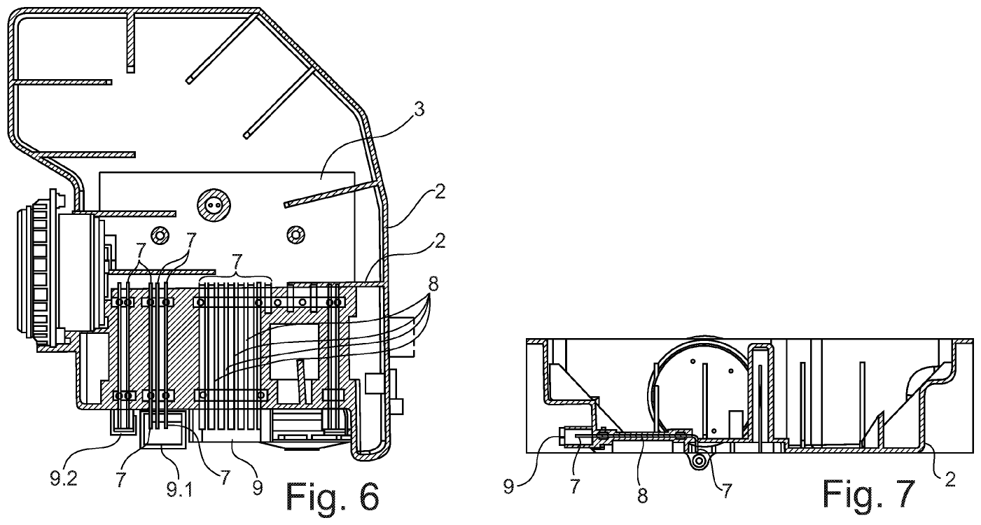

FIG. 1 shows a schematic sectional representation of an exemplary embodiment of the component arrangement according to the invention for a fluid-conducting temperature control system of a battery electric vehicle. The component arrangement 1 has a housing body 2 made by means of a plastic injection molding process, in which a formation 3 for receiving and retaining an electric control unit 4 and a further formation 5 for receiving and retaining an electric pump 6 are formed. The housing body 2, which is provided as a fluid reservoir for the temperature control system of an electric vehicle in the exemplary embodiment shown, has at least one fluid interface in the form of an opening 16, which is not shown in FIG. 1 due to the sectional representation. Electrical contact elements 7 are arranged in the formations 3 and 5 and are connected to each other by electrical conductors 8. The electrical contact elements 7 are used for electrically contacting the pump 6 received in the formation 5. The electrical contact elements 7 arranged in the formation 3 are used for electrically contacting the control unit 4 received in the formation 3. The electrical conductors 8 lead to a connection position 9 (perspectively covered), which is formed on an outside of the housing body 2. The configuration of the connection position 9 is explained in more detail in FIG. 6, for example. The electrical conductors 8, which electrically connect the electrical contact elements 7 to each other at the connection position 9 and in the formations 3 and 5, are integrated with the housing body 2 by being over-molded with the material thereof. The electrical conductors 8 thus run in the wall of the housing body 2. The electrical contact elements 7 formed in the formations 3 and 5 are arranged in such a way that they correspond to the electrical contact elements 7 of the electrically operable components received in the formations 3 and 5, so that the electrically operable components are electrically contacted by plugging them into the formations 3 and 5 with the electrical contact elements 7 arranged in the formations 3 and 5. The formation 5 is formed in such a way that it receives the pump 6 with its back. The electrical contact elements 7 arranged in the formation 3 correspond to the electrical contact points of the control unit 4 that is receivable in the formation 3.

The pump 6 is connected to a plastic housing part 10 of a fluid line system of the temperature control system. The housing body 2 is covered with a cover 11. The cover 11 can also be a plastic part made by means of a plastic injection molding process. Furthermore, in the example shown in FIG. 1, the formation 3 receiving the control unit 4 is covered with a cover 12, which can also be a plastic part made by means of a plastic injection molding process.

The electrical conductors 8 integrated with the housing body 2 are surrounded by the material of the housing body 2 and are electrically insulated from each other.

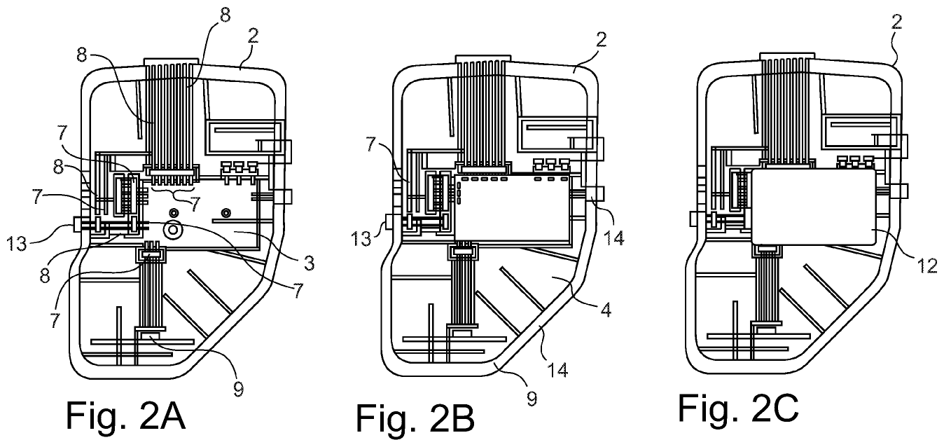

FIGS. 2A, 2B and 2C show sectional representations of the housing body 2 shown in FIG. 1. Here, FIG. 2A shows the housing body 2 with the formation 3 for receiving the control unit 4. A plurality of electrical contact elements 7 are arranged in the formation 3, which are provided for electrically contacting the control unit 4 that is receivable in formation 3. The electrical contact elements 7 are each formed at the ends of the electrical conductors 8. In this case, some of the electrical conductors 8 lead to the connection position 9. Two further electrical conductors 8 lead to a sensor interface 13 which is arranged on an outside of the housing body 2. Further electrical conductors 8 open into the formation 5 in order to be electrically contacted there with a pump 6 which is receivable in the formation 5 and which is not shown in FIG. 2A.

FIG. 2B shows the housing body 2 shown in FIG. 2A, with the electric control unit 4 being received in the formation 3. The electric control unit 4 is retained in the formation 3 by a press fit. The electric control unit 4 has a plurality of electrical contact points 14 which correspond to the electrical contact elements 7 arranged in the formation 3, so that the electrical contact elements 14 of the control unit 4 are connected to the electrical conductors 8 via the electrical contact elements 7. Electrical connections thus exist between the connection position 9 and the control unit 4, between the sensor interface 13 and the control unit 4, and between the pump 6 (not shown) and the control unit 4.

FIG. 2C shows the housing body 2 shown in FIGS. 2A and 2B, the formation 3, in which the electric control unit 4 is received, being covered by the cover 12.

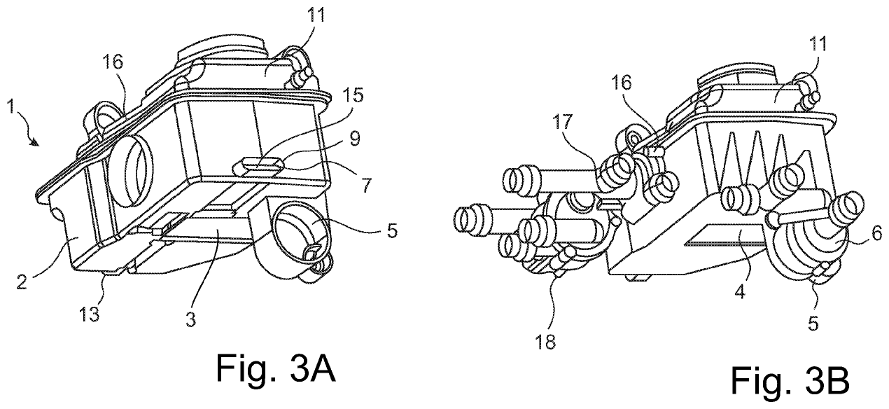

FIGS. 3A and 3B show three-dimensional representations of the component arrangement 1 shown in FIG. 1. Here, FIG. 3A shows the housing body 2 with the formation 3 for receiving the electric control unit 4 and the formation 5 for receiving the electric pump 6 without the electric control unit 4 and the electric pump 6. The housing body 2 and the cover 11 form a cavity which serves as a fluid reservoir. A plug-in housing 15 is formed from the material of the housing body 2 at the connection position 9. The electrical contact elements 7 of electrical conductors 8 are arranged in this formation forming the plug-in housing 15. The electrical conductors 8 are covered by the material of the housing body 2. For electrically contacting, a plug of the vehicle electrics can be plugged into the plug-in housing 15 at the connection position 9. The sensor interface 13 is also arranged on an outside of the housing body 2. Furthermore, the housing body 2 has an opening 16 as a fluid interface with a fluid line network of the temperature control system.

FIG. 3B shows the component assembly 1 shown in FIG. 3A, wherein the electric pump 6 is inserted in the formation 5 and the control unit 4 is inserted in the formation 3. The opening 16 is connected to the fluid line network 17 of the temperature control system. In the representation shown, the fluid line network 17 comprises a pump valve arrangement 18 of the temperature control system.

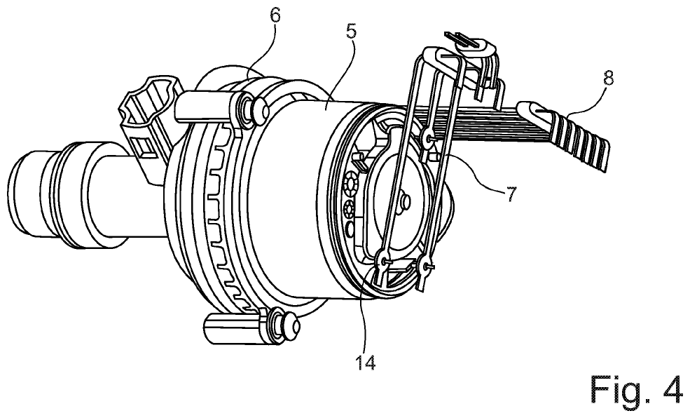

FIG. 4 shows a schematic representation to explain electrically contacting of an electrically operated component of the component arrangement according to the invention. Specifically, FIG. 4 shows electrically contacting of an electrical pump 6 received in the formation 5, with only the pump 6 with the electrical contact elements 7 positioned in the formation 5 and the electrical conductors 8 without the housing body 2 surrounding the electrical conductors 8 being shown in FIG. 4 for clarity. Furthermore, FIG. 4 shows a configuration of the electrical conductors 8 as they are arranged inside the housing body 2. The electrical contact elements 7 have openings into which the electrical contact points 14 of the electrical pump 6 are plugged in. The electrical contact elements 7, which are formed at the ends of the electrical conductors 8, thus correspond to the electrical contact points 14 of the electrical pump 6. Receiving or plugging in the electrical pump 6 into the formation 5 thus leads to electrically contacting the electrical pump 6.

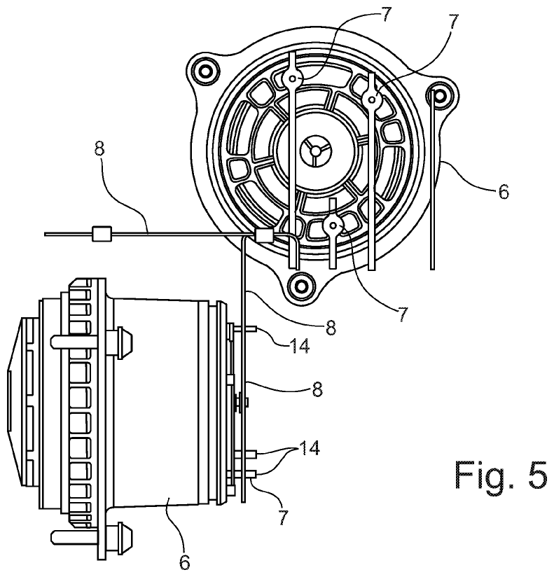

FIG. 5 shows a schematic representation of a configuration of electrical conductors 8 with electrical contact elements 7 within the component arrangement 1, wherein the housing body 2 is omitted for clarity. The configuration comprises a plurality of electrical conductors 8 with electrical contact elements 7, with which the electrical pumps 6 are electrically contacted with their electrical contact points 14. The positioning of the electrical contact elements 7 and the pattern of the electrical conductors 8 is ensured by deflection positions at which the electrical conductors 8 are bent.

FIG. 6 shows a sectional representation of an exemplary embodiment of the housing body 2 of the component arrangement 1. The electrical conductors 8 are integrated in the material of the housing body 2. The electrical contact elements 7 are formed at the ends of the electrical conductors 8. At the connection position 9, which is formed as a plug-in housing from the plastic material of the housing body 2, seven electrical contact elements 7 are arranged side by side. An electrical conductor 8 is assigned to each of the electrical contact elements 7. A further connection position 9.1 with three electrical contact elements 7 and electrical conductors 8 assigned to the electrical contact elements 7 is arranged next to the connection position 9. Furthermore, in addition to the connection position 9.1, another connection position 9.2 is formed with two electrical contact elements 7, with each of these electrical contact elements 7 being assigned an electrical conductor 8. Plug-in housings made of the material of the housing body 2 are formed at the connection positions 9.1 and 9.2. Plugs from the vehicle electrics can be plugged into the plug-in housings. Starting from the connection positions 9, 9.1 and 9.2, the electrical conductors 8 extend through the material of the housing body 2 and open into the formation 3 with their electrical contact elements 7, in which the electric control unit 4 is receivable. By receiving the control unit 4 in the formation 3, the electric control unit 4 is electrically contacted with the electrical conductors 8 via the electrical contact elements 7.

FIG. 7 shows a further sectional representation of the housing body 2 of the component arrangement 1 according to the invention. The sectional representation of the housing body 2 shows the electrical contact elements 7 formed in the wall of the housing body 2 at the connection position 9, which are connected to each other by electrical conductors 8 which are integrated in the material of the housing body 2.

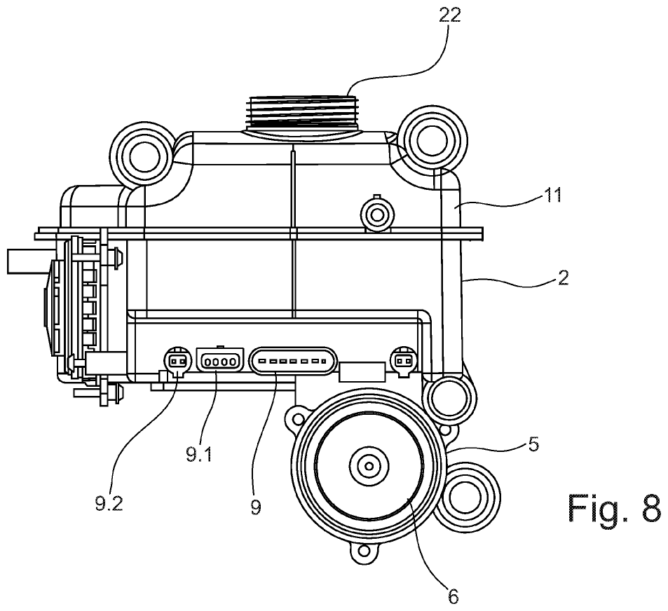

FIG. 8 shows a schematic representation of an exemplary embodiment of the component arrangement 1 according to the invention. The housing body 2 is shown with a cover 11, with connection position 9, 9.1 and 9.2 also being apparent from the view shown. The representation also shows a plan view of the pump 6 which is received in the formation 5. The cover 11 has a formed opening 22 with an external thread. The opening 22 serves as a further fluid interface with the fluid line network of the temperature control system.

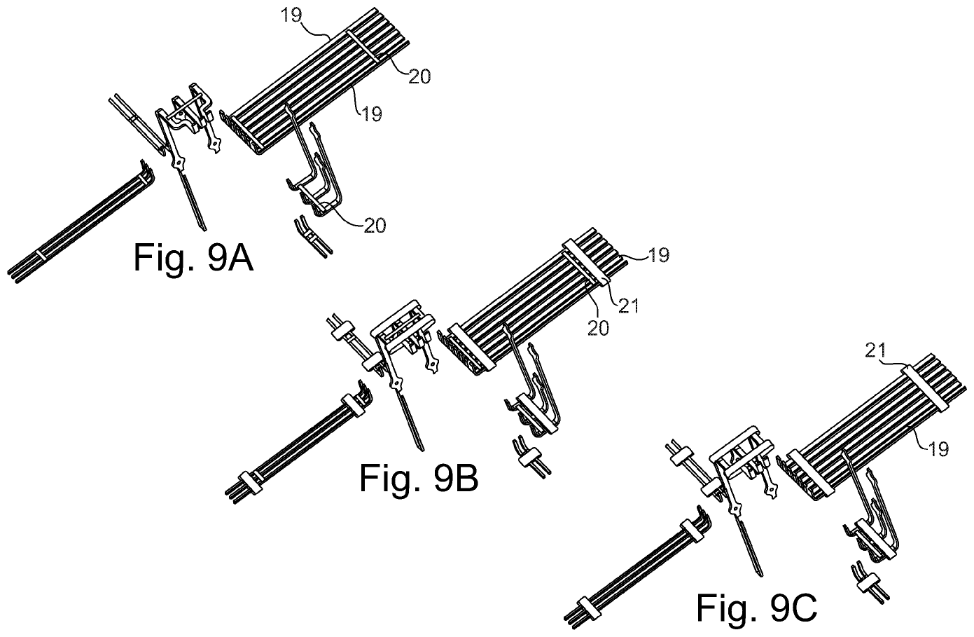

FIGS. 9A, 9B and 9C show schematic representations for a more detailed explanation of the method for manufacturing the housing body 2 of the component arrangement 1 according to the invention. In the method for manufacturing the component arrangement 1 according to the invention, a plurality of electrical conductor tracks 19, which later on form the electrical conductors 8, are separated out of an electrically conductive flat material contiguously at connecting bridges, and then at least partially over-molded with a plastic material such that at least two electrical conductor tracks 19 each are kept together by the plastic over-mold as retaining bridges 21. The electrical conductor tracks 19 kept together in this manner are placed in an injection mold and then over-molded by a plastic material to form the housing body (2) for the component arrangement 1.

In FIG. 9A, the electrical conductor tracks 19 are shown, which are arranged contiguously with the connecting bridges 20. The connecting bridges 20 are partially formed or point-to-point connections between the spaced-apart electrical conductor tracks 19. These connecting bridges 20 are created when the electrical conductor tracks 19 are separated from the electrically conductive flat material. FIG. 9A already shows a progress in the method, in which the electrical conductor tracks 19 are connected to each other at the connecting bridges 20 and bent or folded in order to ensure a desired configuration of the electrical conductor tracks 19. The bent electrical conductor tracks 19 form a three-dimensional conductor track configuration.

FIG. 9B shows the configuration of the electrical conductor tracks 19 shown in FIG. 9A, wherein the electrical conductor tracks 19, which are arranged together, are each partially over-molded with plastic material, as a result of which the retaining bridges 21 are formed.

In a further step, which is shown in FIG. 9C, the connecting bridges 20 are cut from the electrical conductor tracks 19, as a result of which the conductor tracks 19 are electrically separated from each other. In this case, the electrical conductor tracks 19 are held in their position by the retaining bridges 21, so that the desired configuration of the electrical conductor tracks 19 is retained even after the connecting bridges 20 have been cut.

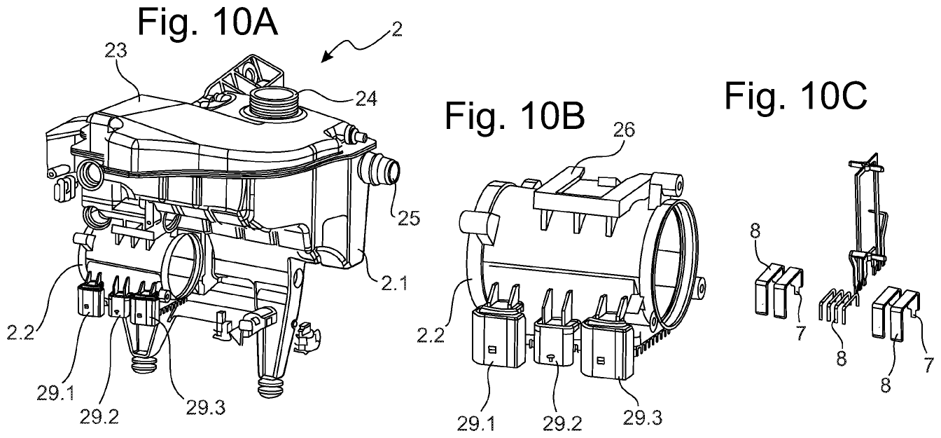

FIGS. 10A, 10B and 10C show schematic representations of an exemplary embodiment of a refinement of the housing body 2 of the component arrangement 1. In this refinement, the housing body 2 is formed by assembling two housing body parts 2.1 and 2.2 made by means of the plastic injection formation process. FIG. 10A shows a first housing body part 2.1 as a fluid container with an opening 25 for a fluid of the fluid-conducting temperature control system. In this case, the first housing body part 2.1 has a cover 23 with an opening 24, the opening 24 also serving as a fluid interface for a fluid of the fluid-conducting temperature control system. The second housing body part 2.2, which is connected to the first housing body part 2.1, is formed as a pump housing for receiving a pump. The pump housing has a formation formed to receive a pump. The formation is configured in such a way that a pump can be plugged into the pump housing. The electrical conductors 8 are integrated in the material of the pump housing, with the electrical contact elements 7 being arranged in the formation of the pump housing such that a pump is electrically contacted when it is plugged into the pump housing. The pump housing thus serves to retain and electrically contact a pump of the fluid-conducting temperature control system. The electrical conductors 8 and the electrical contact elements 7 can be formed in both housing body parts 2.1 and 2.2, with the housing body parts 2.1 and 2.2 having electrical contact elements 7 at their contact points at which they are connected to each other, which electrically connect the electrical conductors 8 to each other.

Connection positions 29.1, 29.2 and 29.3 are formed on the pump housing in the form of formations forming plug-in housings. The electrical contact elements 7 of the electrical conductors 8 are arranged protected by the formations of the plug-in housing. By plugging in plug-in elements at the connection positions 29.1, 29.2 and 29.3, the electrical conductors 8, which are integrated in the material of the pump housing, are electrically contacted, so that a pump plugged into the pump housing can be supplied with electrical energy.

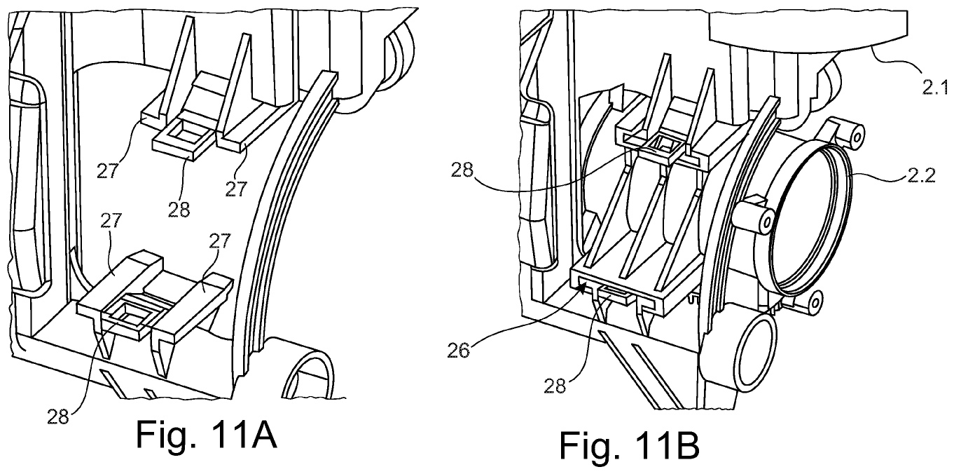

FIG. 10B shows the second housing body part 2.2, which forms the pump housing, in a separate detailed representation. The housing body part 2.2 has a formation formed on the outside in the form of an insertion element 26 as part of a dovetail plug-in connection. The dovetail plug-in connection, which serves to connect the two housing body parts 2.1 and 2.2, is explained in more detail in FIG. 11.

The first housing body part 2.1 and the second housing body part 2.2 are formed from different plastic materials.

FIG. 10C shows the configuration of the electrical conductors 8 and the electrical contact elements 7, as they are arranged in the second housing body part 2.2 forming the pump housing.

FIGS. 11A and 11B show detailed representations of housing body parts 2.1 and 2.2 of the housing body shown in FIG. 10. FIG. 11 serves to explain in more detail the connection between the housing body parts 2.1 and 2.2, which in this case is formed as a dovetail plug-in connection. Here, FIG. 11A shows a detailed representation of the first housing body part 2.1 for receiving the second housing body part 2.2. At this position, insertion flanks 27 are formed in the form of a dovetail as part of a dovetail plug-in connection. These insertion flanks 27 are insertable into the insertion elements 26, which are formed on the second housing body part 2.2 formed as a pump housing, as shown in FIG. 11B. By being inserted into the insertion elements 26, the housing body parts 2.1 and 2.2 are connected to each other. Snap-in elements 28 formed on the first housing body part 2.1 snap into place. These snap-in elements 28 prevent the dovetail plug-in connection from releasing on its own. Electrical contact elements of electrical conductors 8 can be formed on the dovetail plug-in connection, so that the electrical conductors 8 of the housing body parts 2.1 and 2.2 can be electrically connected to each other.

### LIST OF REFERENCE NUMERALS

1 component arrangement
2 housing body
2.1 first housing body part
2.2 second housing body part
3 formation
4 electric control unit
5 formation
6 electric pump
7 electrical contact elements
8 electrical conductors
9 connection position
9.1 connection position
9.2 connection position
10 housing part
11 cover
12 cover
13 sensor interface
14 electrical contact points
15 plug-in housing
16 opening
17 fluid line network
18 pump valve arrangement
19 electrical conductor tracks
20 connecting bridges
21 retaining bridges
22 opening
23 cover
24 opening
25 opening
26 insertion element
27 insertion flanks
28 snap-in elements
29.1 connection position
29.2 connection position
29.3 connection position

1-16. (canceled)

17. A component arrangement for a fluid-conducting temperature control system of a vehicle, the component arrangement comprising:
a housing body made by means of a plastic injection molding process and with at least one formation for receiving and for retaining at least one electrically operated component of the fluid-conducting temperature control system, and
electrical contact elements connected to each other by means of electrical conductors, the electrical contact elements arranged in the at least one formation for electrically contacting one of the at least one electrically operable component received in the at least one formation and in at least one connection position on the housing body, wherein the electrical conductors are integrated with the housing body by being over-molded with a material thereof.

18. The component arrangement according to claim 17, wherein the electrical conductors are formed as flat conductors.

19. The component arrangement according to claim 17, wherein the electrical contact elements are arranged in a formation of the housing body forming a plug-in housing for a plug-in element.

20. The component arrangement according to claim 17, wherein the housing body has the at least one formation each for receiving and for retaining an electric pump, an electric control unit and a valve.

21. The component arrangement according to claim 17, wherein the at least one connection position is arranged on an outside of the housing body.

22. The component arrangement according to claim 17, wherein, in the at least one connection position, a plurality of the electrical contact elements is grouped together, wherein the electrical conductors connected to the electrical contact elements lead from the at least one connection position to the plurality of the electrical contact elements arranged in the at least one formation.

23. The component arrangement according to claim 17, wherein the electrical contact elements arranged in of the at least one formation for receiving and for retaining the at least one electrically operated component are connected to each other by means of the electrical conductors.

24. The component arrangement according to claim 17, wherein in of the at least one formation for receiving and for retaining the at least one electrically operated component is formed such that the at least one electrically operated component is an electric pump receivable in the at least one formation for electrically contacting its back.

25. The component arrangement according to claim 17, wherein the electrical conductors are formed from a bent lead frame.

26. The component arrangement according to claim 17, wherein the housing body is formed to be composed of at least two housing body parts made by means of a plastic injection molding process, wherein a first one of the at least two housing body parts is formed as a fluid container with an opening for a fluid of the fluid-conducting temperature control system, and wherein a second one of the at least two housing body parts is formed as a pump housing.

27. The component arrangement according to claim 26, wherein the first one of the at least two housing body parts and the second one of the at least two housing body parts are formed from different plastic materials or different plastic material compositions.

28. The component arrangement according to claim 26, wherein each of the at least two housing body parts has a formation formed on an outside as an element of a plug-in connection, so that the at least two housing body parts are able to be plugged together.

29. A method for manufacturing the housing body for the component arrangement according to claim 17, wherein a plurality of electrical conductor tracks is separated out of an electrically conductive flat material contiguously at connecting bridges, and then at least partially over-molded with a plastic material such that, after cutting the connecting bridges, at least two of the plurality of electrical conductor tracks each are kept together by the plastic over-mold as retaining bridges, wherein the plurality of electrical conductor tracks kept together in this manner are placed in an injection mold and then over-molded by a plastic material to form the housing body.

30. The method according to claim 29, wherein the plurality of electrical conductor tracks connected to each other at the connecting bridges are punched out of the electrically conductive flat material or separated out of the electrically conductive flat material by means of a laser cutting process as a contiguous network.

31. The method according to claim 29, where the plurality of electrical conductor tracks are bent according to a pre-determined configuration before being placed in the injection mold.

32. The method according to claim 29, wherein the retaining bridges and the housing body are made of a same plastic material.
